(19) United States
(12) Patent Application Publication
(10) Pub. No.: US 2014/0351148 A1
(43) Pub. Date: Nov. 27, 2014

(54) MAINTENANCE INFORMATION COORDINATION SYSTEM

(71) Applicants: Hiroshi Yoshikawa, Tokyo (JP); Masato Arai, Tokyo (JP)

(72) Inventors: Hiroshi Yoshikawa, Tokyo (JP); Masato Arai, Tokyo (JP)

(73) Assignee: HITACHI, LTD., Tokyo (JP)

(21) Appl. No.: 14/364,609

(22) PCT Filed: Mar. 29, 2012
(86) PCT No.: PCT/JP2012/058320

§ 371 Date: Jun. 11, 2014

(51) Int. Cl. G06Q 10/00

(52) U.S. Cl. CPC G06Q 10/20
USPC 705/305

(57) ABSTRACT

A maintenance information coordination system coordinates maintenance-related information held by a user of a machine or held by an independent maintenance service provider company of the machine. Maintenance-related information is held by a provider of the machine. A user machine inference unit of the maintenance information coordination system infers a machine identifier provided by the provider of the machine, which operates in a zone for which maintenance work information has been recorded from a provider machine information storage unit, a user information storage unit and an operation information storage unit. It further infers a mapping relation between the machine identifier assigned by the provider and an identifier of the machine assigned by its user from operation information of the machine and information in a user machine information storage unit, and a maintenance work information storage unit and stores the mapping relation into an integrated maintenance information storage unit.

### TECHNICAL FIELD

The present invention relates to a system that coordinates information items about maintenance of machines.

### BACKGROUND ART

To allow construction machines, working machines, and moving machines to operate in stable condition, it is important to maintain a machine at a suitable time before the machine suffers from a fault. For this purpose, time-based maintenance has been performed, i.e., periodic maintenance is executed according to a inspection or replacement cycle which has been set for each of parts constituting a machine. In recent years, condition-based maintenance/predictive maintenance is put into practice; this monitors the condition of a machine and executes maintenance when the machine has reached a particular condition that has been set beforehand.

In order to maintain a machine properly, it is necessary to prepare parts to meet the time to execute maintenance. Machine manufacturing and sales companies (hereinafter referred to as providers) attempt to solve a problem of stock-out and excess stock of parts necessary for maintenance by predicting demands of parts in future from the operation condition of individual machines and maintenance work execution histories.

Patent Literature 1 discloses a working machine management system in which a part replacement time management system that infers part replacement time by using information (e.g., maintenance work history information) in an external database is interlinked to a working machine remote operation management system that manages operation information by Web service.

### CITATION LIST

### Patent Literature

Patent Literature 1: Japanese Unexamined Patent Application Publication No. 2008-117177

Patent Literature 2: Japanese Unexamined Patent Application Publication No. 2007-226532

### SUMMARY OF INVENTION

### Technical Problem

A machine user or a maintenance service provider other than a machine provider (referred to as an independent maintenance service provider) may purchase parts necessary for maintenance from the machine provider and execute maintenance work. In such a case, maintenance work history information is stored at the user or independent maintenance service provider. In Patent Literature 1 mentioned above, when part replacement time is inferred, the operation information (dynamic condition information) on a machine for which part replacement time should be inferred and information (maintenance work history information) relevant to that machine in an external database are used. However, in a case where the machine provider operates the working machine management system and the user or independent maintenance service provider holds the external database, an identifier of a machine in the working machine remote operation management system of the provider may differ from an identifier of that machine in the maintenance work history information in the external database. In this case, because mapping cannot be easily made between the operation information and the maintenance work history information, the time to replace a part for use in each individual machine cannot be accurately inferred.

Thus, a main object of the present invention, which has been contrived in view of the above problem, is to provide a technique that can make it possible to coordinate maintenance related information that the user or independent maintenance service provider holds and maintenance related information that the provider holds.

### Solution to Problem

A maintenance information coordination system of the present invention is as follows: a maintenance information coordination system that coordinates a plurality of information items about maintenance of machines, including a provider machine information storage unit storing information about machines including machine identifiers assigned by a provider of machines; a user information storage unit storing information about users of the machines; an operation information storage unit storing information about operation locations and machine operation conditions of the machines; a maintenance work information storage unit storing information about maintenance work for the machines; a user machine information storage unit storing information about machines including machine identifiers assigned by a user of machines; and an integrated maintenance information storage unit storing information about mapping relations between the provider machine information and the user machine information.

The maintenance information coordination system further includes a user machine inference unit that, for a machine operating in an area for which the mapping relations is going to be inferred, infers an identifier assigned to the machine by the machine provider from the provider machine information, the user information, and the operation information, further infers a machine identifier assigned by the user to the machine with the above identifier from the operation information, the user machine information, and the maintenance work information, and stores a mapping relation between the machine identifier assigned by the provider and the machine identifier assigned by the user into the integrated maintenance information storage unit.

In another aspect of the present invention, the maintenance information coordination system includes a part shipment information storage unit storing information about shipment of maintenance parts for machines anda replacement part information storage unit storing information about replacement parts for machines, and further includes a maintenance location inference unit that, after processing performed by the user machine inference unit, infers from the maintenance work information a location for which maintenance work was executed and work action for respective maintenance work included in the maintenance work information, infers a replacement part for use in the location from a result of the above inference and the replacement part information, and, if the work action is part replacement, infers a transaction identifier relevant to the replacement part from the part shipment information, and stores the transaction identifier into the integrated maintenance information storage unit.

In yet another aspect of the present invention, the user machine inference unit receives a machine identifier assigned by the user from a work management system that manages a user's maintenance work schedules, acquires candidate machine identifiers assigned by the provider which may correspond to the machine identifier assigned by the user from the integrated maintenance information storage unit and transmits these candidate machine identifiers to the work management system, receives information specifying a machine identifier assigned by the provider corresponding to the machine identifier assigned by the user from the work management system, and, after deciding that the information represents a mapping relation that is uniquely determined from the provider machine information or other mapping relations stored in the integrated maintenance information storage unit, stores the mapping relation into the integrated maintenance information storage unit.

In yet another aspect of the present invention, with regard to a part whose replacement time information is transmitted to the work management system, the user machine inference unit transmits a request for preferential supply such as preferential allocation of a quantity of the part available to the user or selling at a discount price to the part sales system and transmits the result of the request as part supply information to the work management system.

### Advantageous Effects of Invention

According to the present invention, it becomes possible to coordinate maintenance related information that the machine user or independent maintenance service provider holds and maintenance related information that the machine provider holds.

### BRIEF DESCRIPTION OF DRAWINGS

FIG. 1 is a network structure diagram including a maintenance information coordination system in an embodiment disclosed herein.

FIG. 2 is an example of machine information that a provider holds in an embodiment disclosed herein.

FIG. 3A is an example of user information that a provider holds in an embodiment disclosed herein.

FIG. 3B is an example of user information that a provider holds in an embodiment disclosed herein.

FIG. 4 is an example of operation information for each machine that a provider holds in an embodiment disclosed herein.

FIG. 5 is an example of a part shipment history that a provider holds in an embodiment disclosed herein.

FIG. 6 is an example of a maintenance work history that a user holds in an embodiment disclosed herein.

FIG. 7 is an example of machine information that a user holds in an embodiment disclosed herein.

FIG. 8 is an example of replacement parts list that a provider holds in an embodiment disclosed herein.

FIG. 9A is an example of integrated maintenance information that is generated by the maintenance information coordination system in an embodiment disclosed herein.

FIG. 9B is another example of integrated maintenance information that is generated by the maintenance information coordination system in an embodiment disclosed herein.

FIG. 9C is another example of integrated maintenance information that is generated by the maintenance information coordination system in an embodiment disclosed herein.

FIG. 9D is another example of integrated maintenance information that is generated by the maintenance information coordination system in an embodiment disclosed herein.

FIG. 10 is a diagram depicting a vision of making mapping between a provider's maintenance information and a user's maintenance information.

FIG. 11A is an example of a user machine inference procedure in an embodiment disclosed herein.

FIG. 11B is an example of a user machine inference procedure in an embodiment disclosed herein.

FIG. 11C is an example of a user machine inference procedure in an embodiment disclosed herein.

FIG. 12 is an example of a maintenance location inference procedure in an embodiment disclosed herein.

FIG. 13 is an example of a screen of a work management system in an embodiment disclosed herein.

FIG. 14 is another example of a screen of the work management system in an embodiment disclosed herein.

FIG. 15 is another example of a screen of the work management system in an embodiment disclosed herein.

FIG. 16 is an example of a procedure for specifying a machine identifier assigned by a provider corresponding to a machine identifier assigned by a user between the maintenance information coordination system and the work management system.

### DESCRIPTION OF EMBODIMENTS

In the following, embodiments of the present invention will be described in detail with the aid of the drawings.

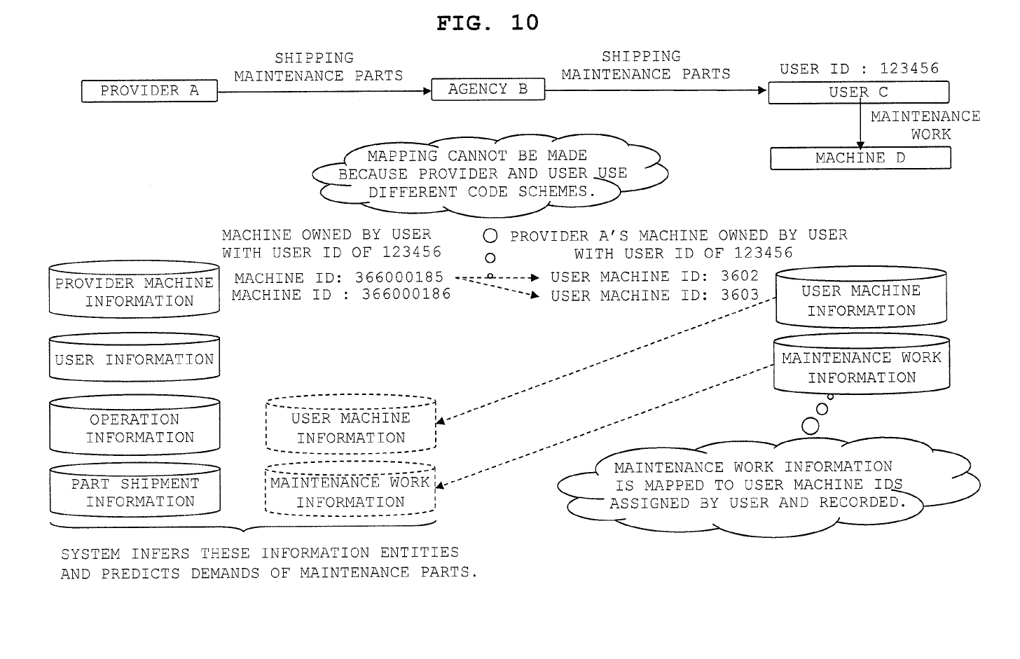

First, a scene of application of an embodiment disclosed herein is depicted in FIG. 10. FIG. 10 depicts a situation where, in a supply chain of maintenance parts for machines, a machine and part manufacturing and sales company (provider A) analyzes the operation condition and the maintenance work execution status (i.e., the consumption status of parts) of a machine of user C and predicts demands of maintenance parts in future. Here, the user of a machine should refer to an organization that owns or uses the machine and should not be taken to be limited to a person who operates the machine directly.

In a case where the user purchases parts from the provider and executes maintenance work of the machine for themselves, in order to accurately infer the time to replace a part according to the status of use of each individual machine, the provider A of the machine, after getting information about maintenance work for the machine which is executed by the user C (such information is generally managed by the user's information system), needs to make mapping between part shipment information managed by the provider A and the user's machine information and operation information (that is, map a part, work, and machine to know which part was consumed in which work for which machine). However, while a machine for which maintenance work was executed and details of the work are described in maintenance work information of the user C, no mapping may be made between user machine information, operation information, and part shipment history which are managed by the provider A and the maintenance work information which is managed by the user C, since an information system that is used by the user C and an information system that is used by the provider A are not always based on a same code scheme (e.g., a scheme of machine IDs for identifying machines). This would be also true in a case where an independent maintenance service provider executes maintenance work.

Therefore, in order to accurately infer the time to replace a part appropriate for each individual machine, it is a requirement to provide a method or system for making mapping between maintenance information managed by the provider and maintenance information managed by the user or independent maintenance service provider.

A maintenance information coordination system as well as a processing method and a program which are run by the maintenance information coordination system are described below.

### (System Structure)

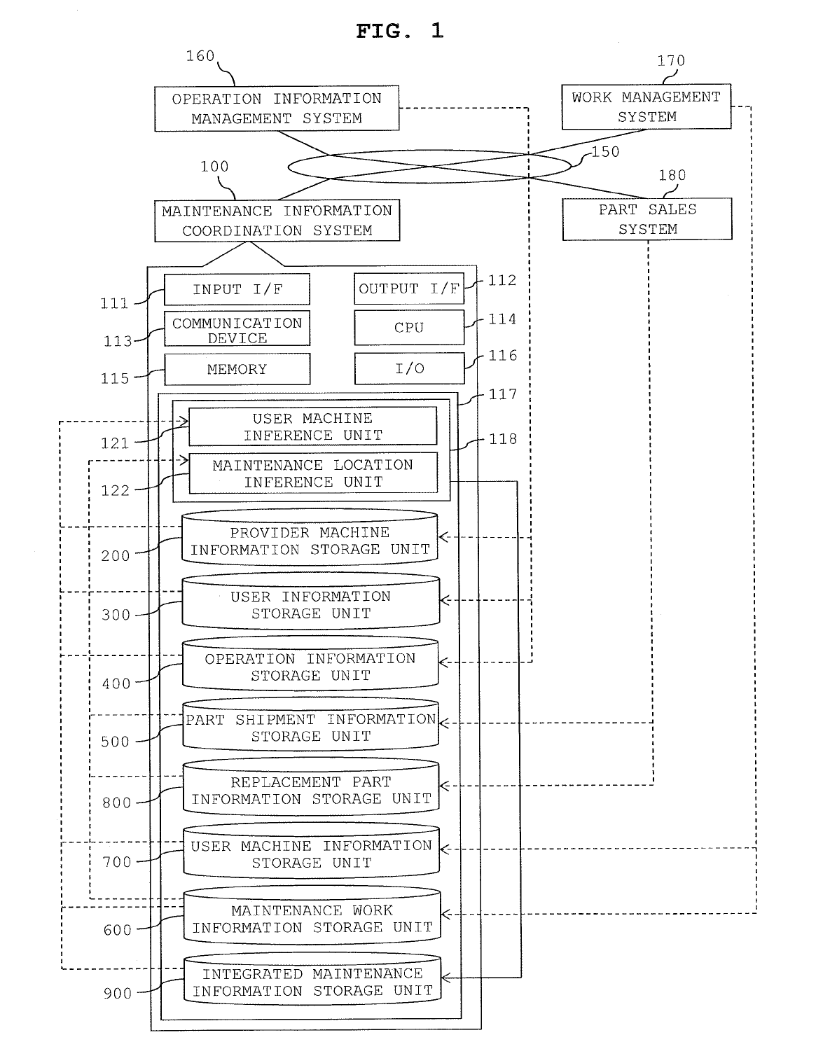

FIG. 1 is a network structure diagram including a maintenance information coordination system (100) (hereinafter referred to as a system 100) of an embodiment disclosed herein. The system 100 generates and records integrated maintenance information (900) by analyzing provider machine information (200), user information (300), and operation information (400) which have been input from an operation information management system 160, user machine information (700) and maintenance work information (600) which have been input from a work management system 170, and part shipment information (500) and a part replacement list (800) which have been input from a part sales system 180.

The system 100 that coordinates a plurality of information items about maintenance of machines, the operation information management system 160 that manages operation information of machines, the work management system 170 that manages user's maintenance work schedules, and the part sales system 180 that supplies machine parts may be configured as separate systems interconnected via a network 150, as in the present embodiment, or a configuration in which functions of the system 100 are provided in any of the operation information management system 160, work management system 170, and part sales system 180 is also possible. The system 100 is provided with a user management function, login function, logout function, session management function, exclusive control function, etc., as appropriate. Each of the system 100, operation information management system 160, work management system 170, and part sales system 180 is implemented by a computer having a CPU, a memory, and a storage device.

The system 100 is provided with a program 118 in a storage device 117 and this program 118 is read and loaded into a memory 115 and executed by a CPU 114 which is an arithmetic device. The system 100 includes, inter alia, an input interface 111 including a keyboard, mouse, various buttons, etc., an output interface 112 including a display, printer, etc., and a communication device 113 such as a wireless LAN for transmitting and receiving data to/from an external device such as an information providing terminal which is not depicted. Using the communication device 113, the system 100 connects to a network 150 of any kind such as, e.g., a public network, Internet, or wireless LAN, via which the system 100 connects to an external device such as an information providing terminal and transmits and receives data to/from the external device. An I/O unit 116 performs data buffering and mediation processing between the functions of the system 100. A request for machine ID mapping is sent from the part sales system 180 of the provider side to the maintenance information coordination system 100.

### (Description of Processes)

The respective entities of processes that the system 100 implements by executing the program 118 are described. The system 100 uses databases such as a machine information storage unit 200. The databases such as the machine information storage unit 200 may be provided in the storage device 117 provided in the computer device of the system 100, as in the present embodiment, or these databases may exist on the network 150 separately from the system 100. In the latter case, it will be expedient that the system 100 is provided with, e.g., a DBMS (Data Base Management System), accesses each of the databases via the network 150, and performs processing such as information registration and information search.

<User Machine Inference Unit 121>

A user machine inference unit 121 of the system 100 acquires machine information, user information, and operation information from the operation information management system 160 via the network 150 and the communication device 113 and stores them respectively into the machine information storage unit 200, a user information storage unit 300, and an operation information storage unit 400. In addition, the user machine inference unit 121 of the system 100 acquires user machine information and maintenance work information from the work management system 170 via the network 150 and the communication device 113 and stores them into a user machine information storage unit 700 and a maintenance work information storage unit 600. Then, the user machine inference unit 121 analyzes each item of information stored in the machine information storage unit 200, user information storage unit 300, operation information storage unit 400, user machine information storage unit 700, and maintenance work information storage unit 600, generates integrated maintenance information, and stores it into an integrated maintenance information storage unit 900. A procedure for generating integrated maintenance information will be described later.

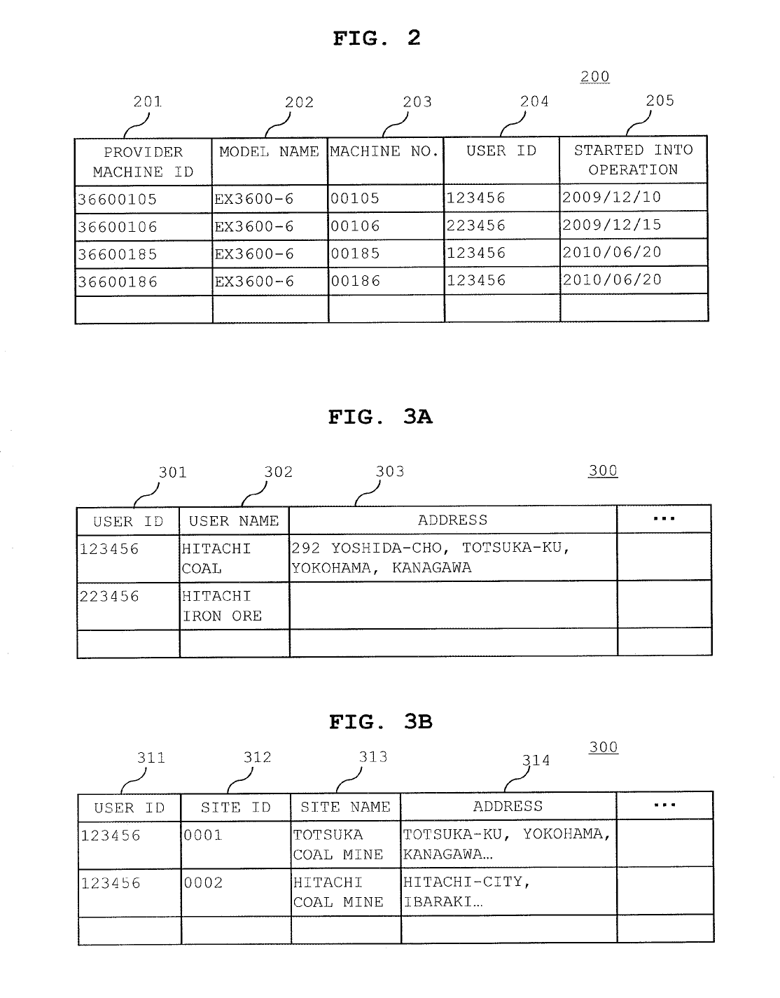

FIG. 2 presents an example of structure of the provider machine information storage unit 200 holding mapping relations between machines and users, which is managed on the provider side. One horizontal row represents information on one machine. A column 201 is for a machine ID which is the identifier of a machine assigned by the provider; a column 202 is for a model name of the machine; a column 203 is for machine number information of the machine; and a column 204 is for a user ID which is the identifier of a user that owns the machine. A column 205 is for a date at which the machine started into operation. In the present embodiment, it is assumed that a machine 10 in the column 201 is uniquely specified from information of a model name in the column 202 and a machine number in the column 203.

FIG. 3 present an example of structure of the user information storage unit 300 holding information about users of machines. FIG. 3A presents a case in which the storage unit holds the names of users and FIG. 313 presents a case in which the storage unit holds detailed information about users. In FIG. 3A, one horizontal row represents one user. A column 301 is for a user's identifier (referred to as a user ID); a column 302 is for the name of the user and a column 303 is for the address of the user (location information of the user). In FIG. 3B, one horizontal row represents one site. Here, the site refers to an area where machines are operating (for example, in the case of mining machines, the site is a mine where the machines are operating). It is assumed that machines operating in the same site are managed by the same manager. A column 311 is for a user ID; a column 312 is for a site's identifier (referred to as a site ID); a column 313 is for the name of the site; and a column 314 is for the address (location information of the site). In an example as presented, although address is used as location information in the columns 303 and 304, the location information may be latitude/longitude or both address and latitude/longitude may be stored. In linkage with a geographical information system, a region corresponding to the site may be stored.

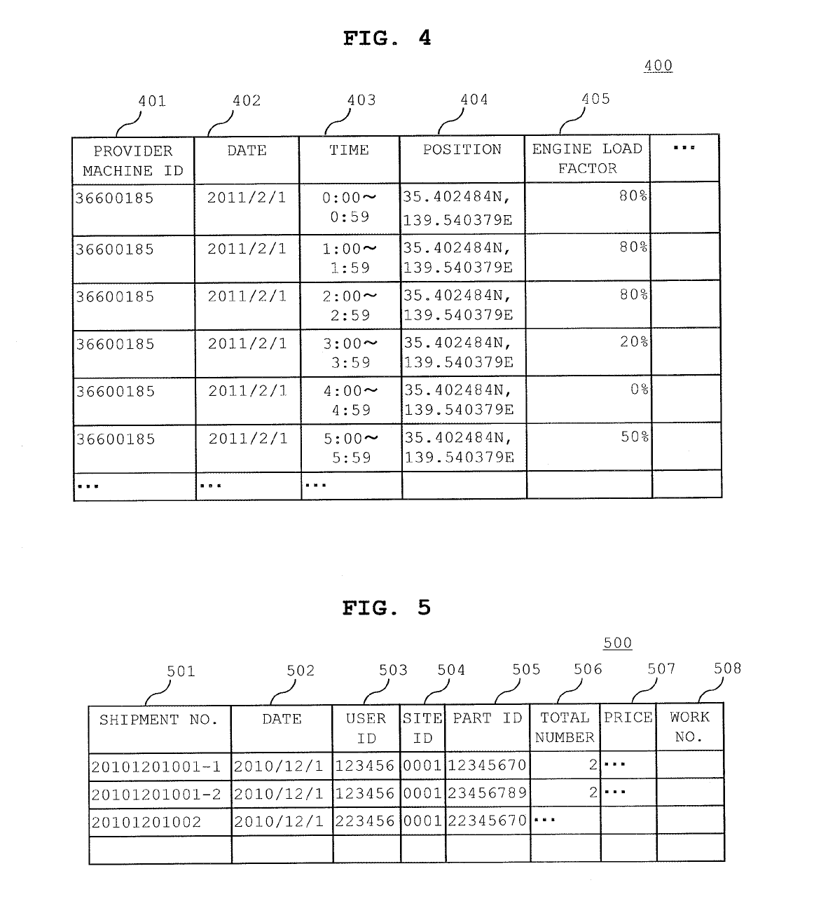

FIG. 4 presents an example of structure of the operation information storage unit 400 holding operation condition of each machine. One horizontal row represents information on operation of one machine for a unit time. A column 401 is for a machine ID; a column 402 is for a date when the operation information was acquired; a column 403 is for time during which the operation information was acquired; a column 404 is for the machine's position information for that time; and a column 405 is for the machine's operation information (also referred to as dynamic condition information) for that time. In an example as presented, one hour is specified as a unit time in the columns 402 and 403 and the machine's position information and operation information for that time are stored. However, a unit time can be fixed to, e.g., 30 minutes and others, depending on the storage capacity provided in the system 100, the communication bandwidth of the network 150, and the capability of communication between a machine and the operation information management system 160 which will be described later.

As for position information in the column 404, the machine's position information is stored as its latitude/longitude information. However, the position information may be an average position of the machine within the unit time or a position thereof at a particular point of time within the unit time (e.g., a point of time of start of the unit time). The machine's position information is assumed to be measured by a Global Positioning System Receiver (GPSR), a wireless positioning system, or the like provided at the machine, transmitted via a network such as a mobile communication network, and stored into the operation information management system 160.

In the example as presented, an engine load factor is stored as the operation information in the column 405. However, information that is stored as the operation information is not limited to the engine load factor and not limited to one kind of information. A plurality of operation information items including, e.g., a maximum oil temperature of an engine, which can be acquired from the machine, may be stored in that column and an additional column.

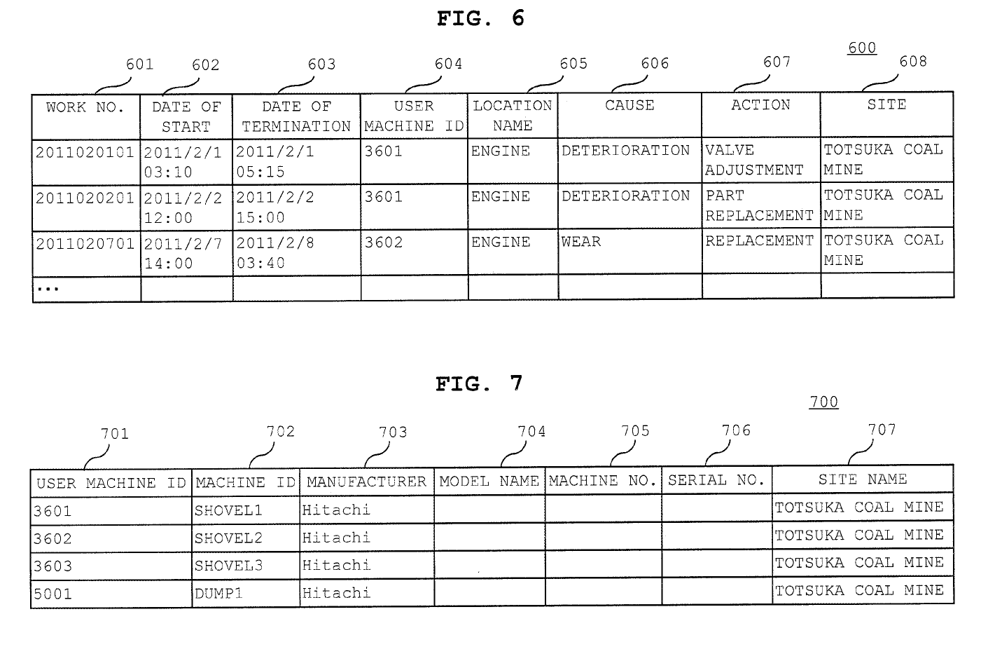

FIG. 6 presents an example of structure of the maintenance work information storage unit 600 recording maintenance work details. One horizontal row represents information on maintenance work. A column 601 is for maintenance work's identifier (referred to as a work number); a column 602 is for a data at which the maintenance work starts; a column 603 is for a date at which the maintenance work terminates; a column 604 is for the identifier of a machine subjected to the work (the identifier of a machine assigned by the user, referred to as a user machine ID); a column 605 is for the name of a location for which the maintenance work was executed in the machine; a column 606 is for a cause by which the maintenance work was needed; a column 607 is for what maintenance work was executed (referred to as action taken); and a column 608 is for the name of a site where the maintenance work was executed.

FIG. 7 presents an example of structure of the user machine information storage unit 700 holding detailed information about each machine, which is managed on the user side. One horizontal row represents information on one machine. A column 701 is for a user machine ID; a column 702 is for a machine name; a column 703 is for a machine manufacture; a column 704 is for a model name of the machine; a column 705 is for machine number information; a column 706 is for a provider machine ID assigned to the machine (the machine identifier set by the provider); and a column 707 is for the name of a site where the machine is put in operation. In an example as presented, the columns 704, 705, and 706 are filled with null values.

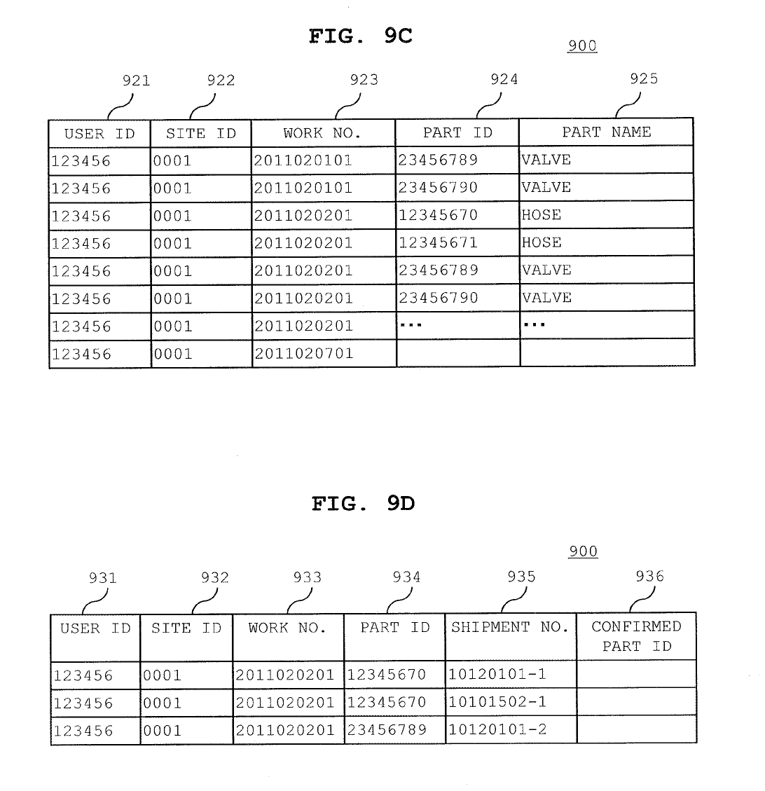

FIG. 9 present an example of structure of the integrated maintenance information storage unit 900 holing information for the provider and the user of a machine to coordinate and execute maintenance work. The user machine inference unit 121 uses FIG. 9A that presents information holding correlations of respective information items of the provider and the user of a machine. A maintenance part inference unit 122 which will be described later uses FIGS. 9B, 9C, and 9D that present information about parts necessary for maintenance.

FIG. 9A is a table (referred to as a user machine mapping table) that mapped between user machine information (700) presented in FIG. 7 and provider machine IDs (201). There may be a plurality of provider machine IDs mapped to one user machine ID. A column 901 is for a user ID; a column 902 is for a site ID; a column 903 is for a machine identifier assigned by the user (user machine ID); a column 904 is for a machine identifier inferred by the system 100 (provider machine ID); a column 905 is for a probability that a machine subject to maintenance work is a machine inferred by the user machine inference unit (referred to as probability 1); and a column 906 is for an ID indicating that the inferred machine ID has been confirmed by the user (referred to as a confirmed machine ID). For example, the table indicates that the probability that a machine (user machine ID=‘3601’) on a first row is a machine with a machine ID of ‘36600105’ is 100%. On the other hand, the table indicates that the probability that a machine (user machine ID=‘3602’) on a second row is a machine with a machine ID of ‘36600185’ is 80% and the probability that a machine on a third row (with the same user machine ID as the machine on the second row) is a machine with a machine ID of ‘36600186’ is 30%.

FIG. 9B is information converted from location name information (605), cause information (606), and action information (607) in maintenance work information (600) presented in FIG. 6 to terms that are defined by the provider. A column 911 is for a user ID; a column 912 is for a site ID; a column 913 is for a user-side work number; column 914 is for a location name; a column 915 is for a part name; a column 916 is for a part name; and a column 917 is for action. These items of information in FIG. 6 are generated by converting the maintenance work information, i.e., the location, part, and work names by natural language processing.

FIG. 9C is a table that mapped between maintenance work information (600) presented in FIG. 6 and the provider's replacement part information (800). A column 921 is for a user ID; a column 922 is for a site ID; a column 923 is for a user-side work number; a column 923 is for a part number; and a column 925 is for a part name.

FIG. 9D is a table that mapped between maintenance work information (600) presented in FIG. 6 and provider's part shipment information (500). A column 931 is for a user ID; a column 932 is for a site ID; a column 933 is for a user-side work number; a column 934 is for a part number; a column 935 is for a shipment number: and a column 936 is for an ID indicating that inferred shipment information is confirmed by the user (referred to as a confirmed part ID).

### <Maintenance Part Inference Unit 122>

A maintenance location inference unit 121 of the system 200 acquires part shipment information (500) and replacement part information (800) from the part sales system 180 via the communication device 113 and stores them respectively into a part shipment information storage unit 500 and a replacement part information storage unit 800. Then, the maintenance part inference unit 121 analyzes information stored in the machine information storage unit 200, user information storage unit 300, operation information storage unit 400, part shipment information storage unit 500, user machine information storage unit 700, maintenance work information storage unit 600, and replacement part information storage unit 800, generates integrated maintenance information, and stores it into the integrated maintenance information storage unit 900.

FIG. 5 presents an example of structure of the part shipment information storage unit 500 holding information about shipped parts. One horizontal row represents shipment information on one part item. A column 501 is for a shipment's identifier (referred to as a shipment number); a column 502 is for a shipment date; a column 503 is for the identifier of a user (user ID) that is the destination of shipment; a column 504 is for the identifier of a site (site ID) of the user that is the destination of shipment; a column 505 is for the identifier of a shipped part (part ID); a column 506 is for the total number of shipped parts; a column 507 is for the price of the part; and a column 508 is for the work number of maintenance work for which the part was used.

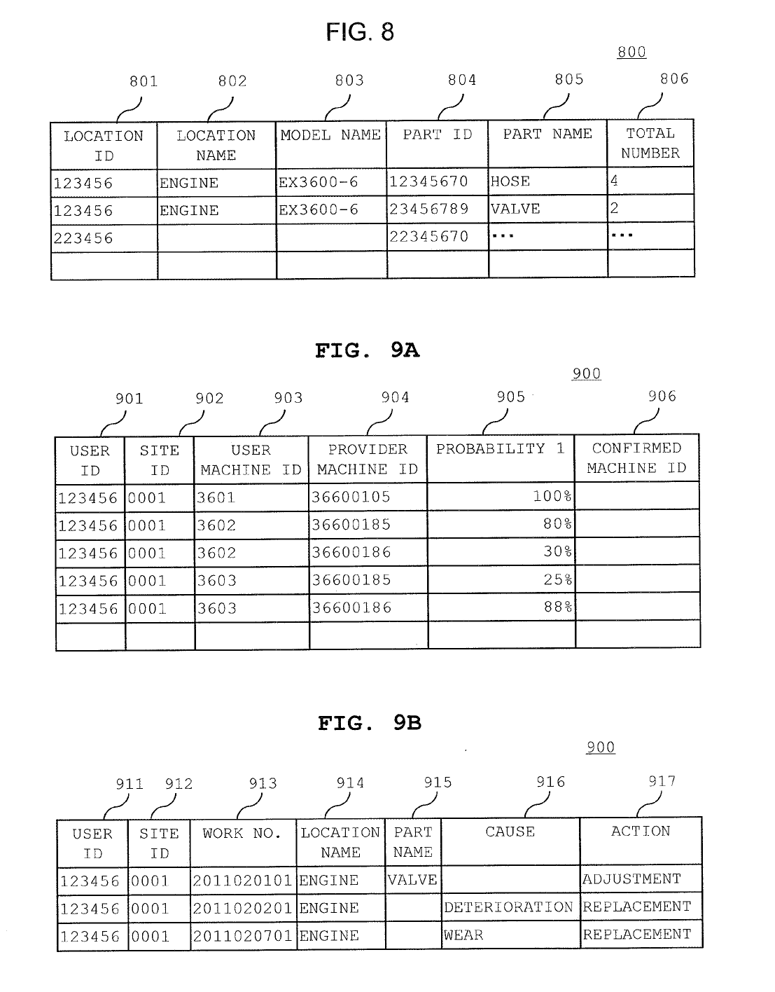

FIG. 8 presents an example of structure of the replacement part information storage unit 800 holding information about an object to which a replacement part applies. One horizontal row represents one part item. A column 801 is for the identifier of a location (referred to as a location ID); a column 802 is for a location name; a column 803 is for the model name of a machine to which a replacement part specified on the row applies; a column 804 is for a part ID; and a column 505 is for a part name.

### <User Machine Inference Procedure>

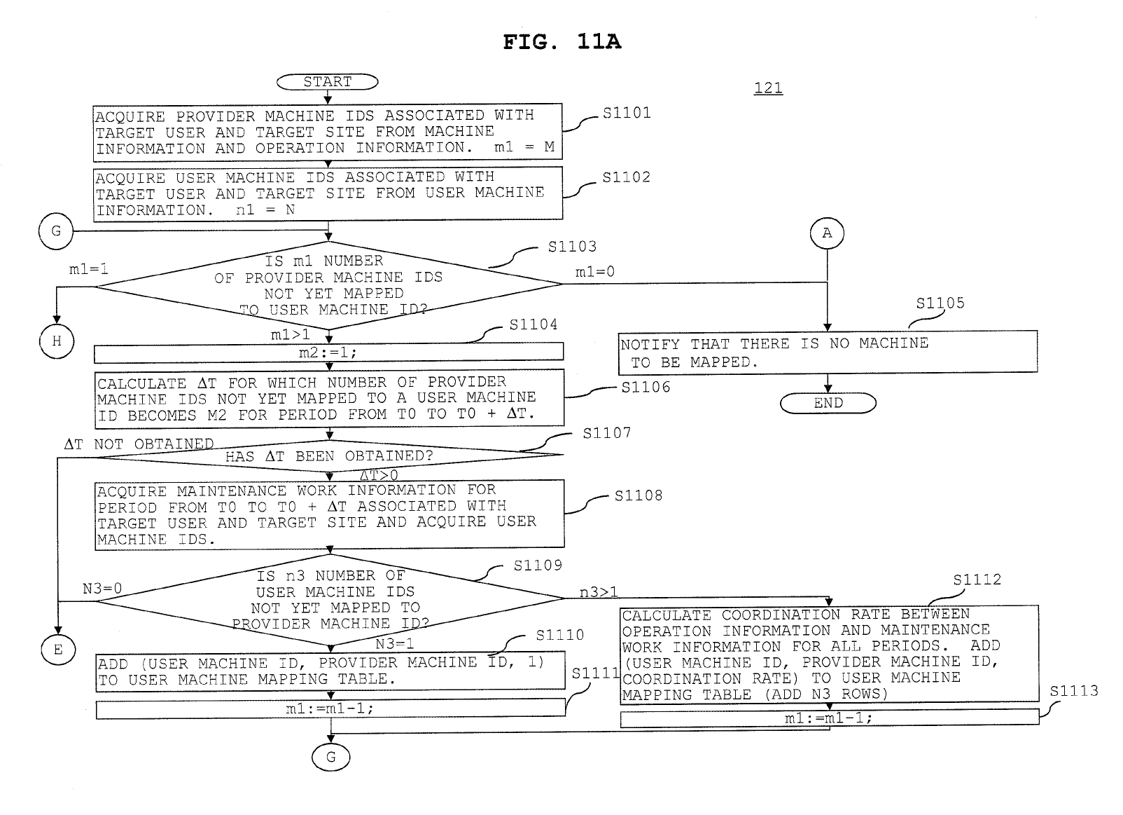

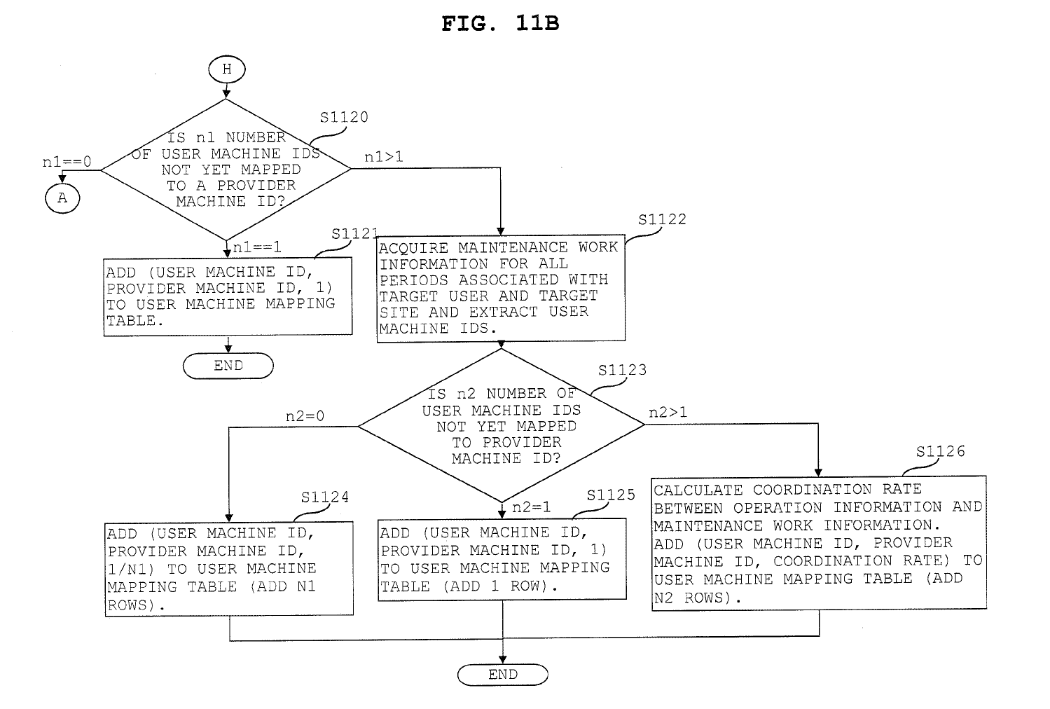

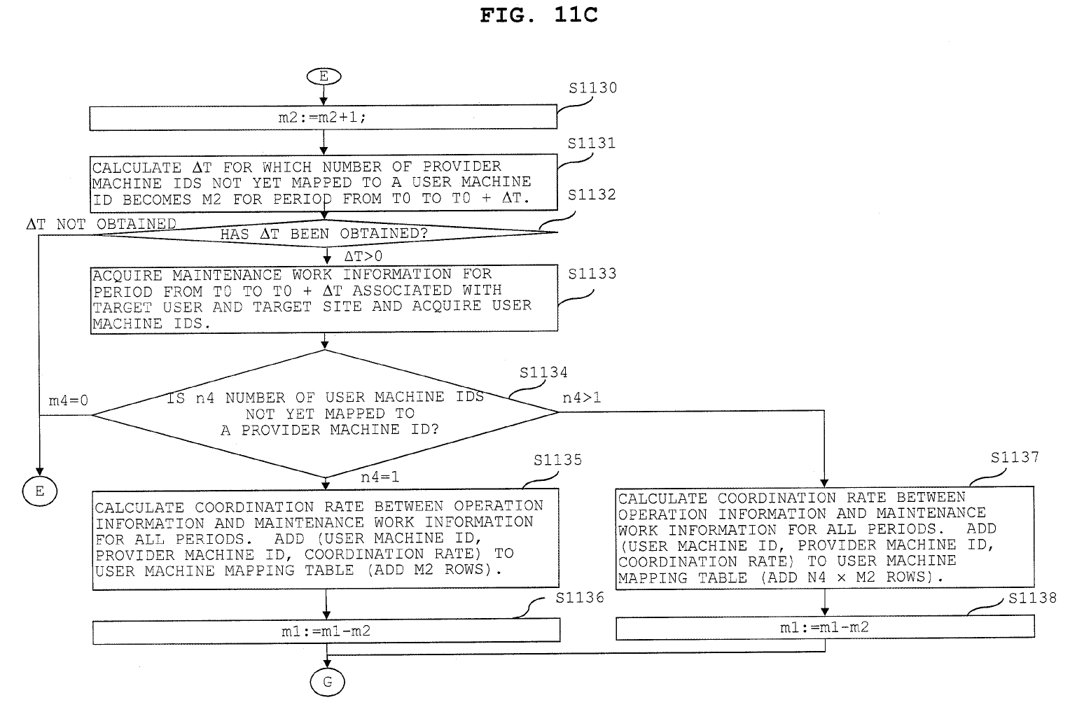

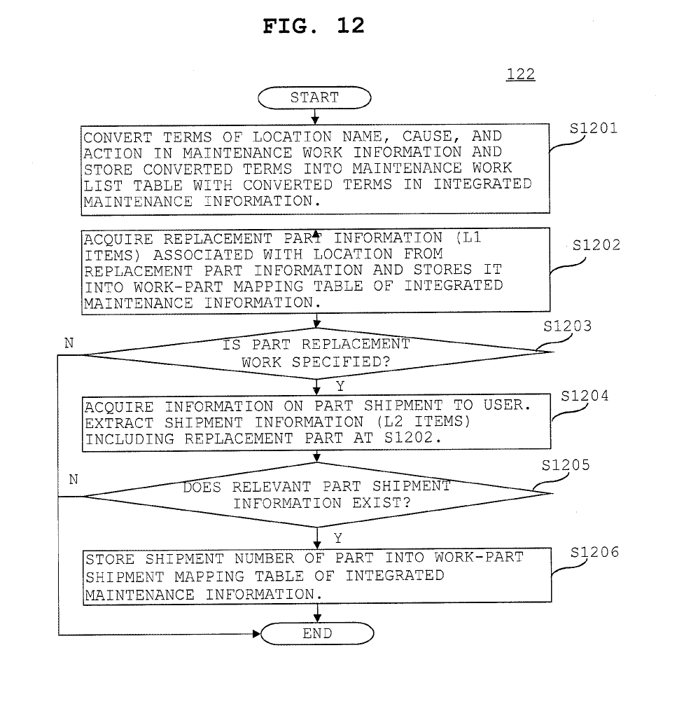

FIGS. 11A, 11B, and 11C are an example of a procedure in which the user machine inference unit 121 of the system 100 generates integrated maintenance information (900).

FIG. 11A is a process flow in a case where mapping between information items relevant to a machine ID can be performed within a predetermined period. FIG. 11B is a process flow in a case where mapping between information items relevant to a user machine ID is performed based on a maintenance history. FIG. 11C is a process flow corresponding to that in FIG. 11A in a case where two or more machines have been put in operation. A process point (E) in the process flow of FIG. 11A indicates a case in which one machine recorded in a maintenance work history was not found within the predetermined period.

In the present procedure, a user for which the system analyzes maintenance related information held by a provider and maintenance related information held by a user and generates integrated maintenance information is referred to as a target user. Some users may have a plurality of sites where machines are put in operation. In this case, the system is assumed to generate integrated maintenance information for a particular site (which is referred to as a target site). Maintenance work information on a target site can be identified by a value in the column 608 as presented in FIG. 6. User machine information and maintenance work information on a target user are assumed to be stored in the user machine information storage unit 700 and the maintenance work information storage unit 600 of the system 100. The above-mentioned target user, target site, and target period are assumed to be specified beforehand via the input interface 111 or the communication device 113 of the system 100. For example, with “Hitachi Coal” (user ID=‘123456’) specified as the target user and “Totsuka Coal Mine” (site ID=‘0001’) specified as the target site, the system executes the user machine interference process. If the system has to generate integrated maintenance information about a plurality of users and sites, the system should repeat the present process, as appropriate.

Using the user ID of the target user as a search key, the user machine inference (UMI) unit 121 acquires the machine IDs of machines operating in the target site from the provider machine information storage unit 200 and the operation information storage unit 400 (S1101). Here, suppose that the number of machines operating in the target site is M and the number of provider machine IDs not yet mapped to a user machine ID is m1. And m1 is set to an initial value of M.

Here, the UMI unit acquires the machine IDs of machines operating in the target site as below. First, it acquires position information of each machine associated with the user ID from the operation information storage unit 400 and calculates a distance between each machine and the target site. As presented in FIG. 4, a machine's position information is stored as its latitude/longitude information in the operation information storage unit 400. Location information of the target site is stored as its address (column 314) in the user information storage unit 300. A distance between two points specified by latitude/longitude and address can be calculated by linkage with a geographical information system. If a plurality of items of position information for a machine during the target period are stored in the operation information storage unit 400, the UMI unit calculates an average of distances between each of the positions given by these items of position information and the target site and takes an average distance as a distance between each machine and the target site.

Then, the user machine inference unit 121 acquires the provider machine IDs of machines for which the distance between each machine and the target site is less than a threshold value. Here, the threshold value is a criterion to determine whether a machine is operating in the target site and is assumed to be preset for the system 100. Alternatively, if a range is set as the site's location information, the UMI unit should acquire the machine IDs of machines whose position falls within the set range.

The user machine inference unit 121 acquires user machine IDs associated with the target user and the target site from the user machine information 700 (S1102). Suppose that the number of user machine IDs is N and the number of user machine IDs not yet mapped to a provider machine ID is n1. And n1 is set to an initial value of N.

The user machine inference unit 121 determines what value m1 has (S1103). The UMI unit proceeds to: S1105, if m1=0; S1120, if m1=1; or S1104, if m1>1.

S1105 is a step that is executed, if there is no combination of a user machine ID and a provider machine ID to be mapped to each other, because there is no user machine ID or there is no provider machine ID. In this case, the UMI unit notifies the part sales system 180 on the provider side that there is no machine ID to be mapped to any user machine ID and terminates the process.

S1120 in FIG. 11B is a step that is executed in a case (H) in which there is one machine whose provider machine ID is not yet mapped to a user machine ID. The user machine inference unit 121 determines what value n1 has, which denotes the number of user machine IDs not yet mapped to a provider machine ID (S1120). The UMI unit proceeds to: S1105, if n1=0; S1121, if n1=1; or S1122, if n1>1.

S1121 is a step that is executed, if m1=1 and n1=1. In this case, one-to-one mapping is made between a user machine ID and a provider machine ID. The user machine inference unit 121 adds a pair of the user machine ID and the machine ID to the user machine mapping table of integrated maintenance information, sets 1 for a value of probability 1, and terminates the process.

S1122 is a step that is executed, if m1=1 and n1>1. That is, there is one machine whose provider machine ID is not yet mapped to a user machine ID, whereas there are a plurality of machines whose user machine ID is not yet mapped to a provider machine ID. The user machine inference unit 121 acquires maintenance work information associated with the target user and the target site from the maintenance work information storage unit 600 and acquires user machine IDs.

Then, the user machine inference unit 121 refers to the user machine mapping table of integrated maintenance information (900), acquires user machine IDs not yet mapped to a provider machine ID out of the user machine IDs acquired at S1122, and determines the number n2 of unprocessed machine IDs in the integrated maintenance information (900) (S1123). The UMI unit proceeds to: S1124, if n2=0; S1125, if n2=1; or S1126, if n2>1.

S1124 is a step that is executed, if m1=1, n1>1, and n2=0. In this case, any of n1 user machine IDs is mapped to a provider machine ID not yet mapped to a user machine ID, but cannot be uniquely specified. The user machine inference unit 121 adds a pair of the user machine ID and the machine ID with respect to each of the n1 user machine IDs to the user machine mapping table of integrated maintenance information, sets 1/n1 for a value of probability 1, and terminates the process.

S1125 is a step that is executed, if m1=1, n1>1, and n2=1. In this case, a user machine ID acquired at S1123 (that is, a user machine ID for which maintenance work information exists) is uniquely mapped to the provider machine ID. Thus, the user machine inference unit 121 adds a pair of the user machine ID and the provider machine ID to the user machine mapping table of integrated maintenance information, sets 1 for a value of probability 1 (905), and terminates the process.

S1126 is a step that is executed, if m1=1, n1>1, and n2>1. In this case, there are n2 user machine IDs that may be mapped to a provider machine ID acquired at S1103, but which user machine ID should be mapped to it cannot be uniquely specified. The user machine inference unit 121 adds a pair of the user machine ID and the machine ID with respect to each of the n2 user machine IDs to the user machine mapping table of integrated maintenance information, sets a “coordination rate” for a value of probability 1 (905), and terminates the process. Here, the coordination rate is a value indicating what degree to which work information relevant to a user machine ID and operation information relevant to a provider machine ID coordinate. Here, the “coordination rate” is defined to be a percentage of time when the engine load factor is less than a fixed value during a period between the start time and the termination time of maintenance work. For example, given that a time zone when the engine load factor for one hour is less than 25% should be regarded as a time zone when maintenance work can be performed, a “coincidence rate” is calculated as follows. In FIG. 6, for maintenance work performed on “2011/2/1”, its start time is “3:10” and its termination time is “5:15”. On the other hand, in FIG. 4, on “2011/2/1”, a time zone when the engine load factor is less than 25% is a period from “3:00” to “5:00” (the engine load factor from 3:00 to 3:59 is regarded as constant). For this time “2011/2/1”, the coincidence rate between maintenance work information and operation time information is calculated as (50+60)/(50+60+15)=0.88.

S1104 in FIG. 11A is a step that is executed, if m1, the number of machines not yet mapped to a user machine ID is larger than 1. The user machine inference unit 121 assigns 1 to a variable m2 and proceeds to S1106. m2 is the number of provider-side machine IDs that the UMI unit tries to map to a user machine ID for a given period ΔT.

At S1106, the user machine inference unit 121 seeks a time interval ΔT for which the number of provider machine IDs not yet mapped to a user machine ID becomes m2 for a period from T0 to T0+ΔT. Here, T0 represents a point of time when a machine was first put into operation in the target site of the target user. For m1 machine IDs, the user machine inference unit 121 can obtain T0 by acquiring the date when the machine started into operation 205 from provider machine information 200.

The user machine inference unit 121 proceeds to: S1108, if it succeeded in obtaining ΔT; or S1130, if it fails to obtain ΔT (S1107).

S1108 is a step that is executed, if the number of machine IDs not yet mapped to a user machine ID for the period from T0 to T0+ΔT is 1. The user machine inference unit 121 acquires maintenance work information for the period from T0 to T0+ΔT and acquires user machine IDs (S1108).

Then, the user machine inference unit 121 refers to the user machine mapping table, acquires user machine IDs not yet mapped to a provider machine ID out of the user machine IDs acquired at S1108, and determines the number n3 of unprocessed machine IDs in the maintenance work information (600) (S1109). The UMI unit proceeds to: S1130, if n3=0; S1110, if n3=1; or S1112, if n3>1.

S1110 is a step that is executed, if the number of provider machine IDs not yet mapped to a user machine ID for the period from T0 to T0+ΔT is 1 and the number of user machine IDs not yet mapped to a provider machine ID is 1. In this case, one-to-one mapping is made between a user machine ID and a provider machine ID. The user machine inference unit 121 adds a pair of the user machine ID and the provider machine ID to the user machine mapping table of integrated maintenance information and sets 1 for a value of probability 1.

Then, the user machine inference unit 121 decrements the value of m1 by one (S1111) and proceeds to S1103.

S1112 is a step that is executed, if the number of provider machine IDs not yet mapped to a user machine ID for the period from T0 to T0+ΔT is 1 and the number of user machine IDs not yet mapped to a provider machine ID is n3. In this case, there are n3 machines whose user machine ID may be mapped to a provider machine ID acquired at S1106. The user machine inference unit 121 adds a pair of the user machine ID and the provider machine ID with respect to each of the n3 user machine IDs to the user machine mapping table of integrated maintenance information and sets a coordination rate” for a value of probability 1.

Then, the user machine inference unit 121 decrements the value of m1 by one (S1113) and proceeds to S1103.

At S1130 in FIG. 11C, the user machine inference unit 121 adds one to the value of m2 and increments the number of provider machine IDs to be mapped to a user machine ID.

At S1131, the user machine inference unit 121 seeks a time interval ΔT for which the number of provider machine IDs not yet mapped to a user machine ID becomes m2 for a period from T0 to T0+ΔT.

The user machine inference unit 121 proceeds to: S1133, if it succeeded in obtaining ΔT; or S1130, if it fails to obtain ΔT (S1132).

S1133 is a step that is executed, if the number of provider machine IDs not yet mapped to a user machine ID for the period from T0 to T0+ΔT is m2. The user machine inference unit 121 acquires maintenance work information for the period from T0 to T0+ΔT and acquires user machine IDs (S1133).

Then, the user machine inference unit 121 refers to the user machine mapping table, acquires user machine IDs not yet mapped to a provider machine ID out of the user machine IDs acquired at S1133, and determines the number n4 of unprocessed machine IDs in the maintenance work information (600) (S1134). The UMI unit proceeds to: S1130, if n4=0; S1135, if n4=1; or S1137, if n4>1.

S1135 is a step that is executed, if the number of provider machine IDs not yet mapped to a user machine ID for the period from T0 to T0+ΔT is m2 and the number of user machine IDs not yet mapped to a provider machine ID is 1. In this case, any of the m2 provider machine IDs is mapped to the user machine ID, but cannot be uniquely specified. The user machine inference unit 121 adds a pair of the user machine ID and each of the provider machine IDs to the user machine mapping table of integrated maintenance information and sets a “coordination rate” for a value of probability 1.

Then, the user machine inference unit 121 subtracts m2 from m1 (S1136); that is, subtracts the number m2 of provider machine IDs that have all been mapped to a user machine ID in the foregoing process from the number m1 of unprocessed machine IDs and proceeds to S1103.

S1137 is a step that is executed, if the number of provider machine IDs not yet mapped to a user machine ID for the period from T0 to T0+ΔT is m2 and the number of user machine IDs not yet mapped to a provider machine ID is n4. In this case, any of the m2 provider machine IDs is mapped to any of the n4 user machine IDs. The user machine inference unit 121 adds a pair of each of the user machine IDs and each of the provider machine IDs to the user machine mapping table of integrated maintenance information and sets a coordination rate” for a value of probability 1.

Then, the user machine inference unit 121 subtracts m2 from m1 (S1138); that is, it subtracts the number m2 of provider machine IDs that have all been mapped to a user machine ID in the foregoing process from the number m1 of unprocessed machine IDs and proceeds to S1103.

### <Maintenance Location Inference Procedure>

FIG. 12 is an example of a procedure in which a maintenance location inference unit 122 of the system 100 generates integrated maintenance information. The process of FIG. 12 is subsequent to the process of FIG. 11.

The maintenance location inference (MLI) unit 122 acquires maintenance work information stored in the maintenance work information storage unit 600, converts terms regarding locations and work included in the location name (column 605), cause (column 606), and action (column 607) to terms defined by the provider, using natural language processing technology such as an ontology dictionary, and stores the converted terms into a maintenance work list table with terms converted in the integrated maintenance information storage unit 900 (S1201). For example, in Patent Literature 2, a method for coordinating (converting) a database including object data and predicate data by an ontology data structure is disclosed. Using such a technique, for example, the MLI unit converts a term “valve adjustment” in the column 607 on the first row in FIG. 6 and stores a term “valve” into the “part name” column 915 and a term “adjustment” into the “action” column 917; it converts a term “part replacement” in the column 607 on the second row in FIG. 6 and stores a term “replacement” into the object column 917.

Then, the maintenance location inference unit 122 acquires a model name from the machine information storage unit using, as a search key, a machine ID in a work-machine mapping table in the integrated maintenance information. Using the acquired model name and converted location name as a search key, the MLI unit searches for replacement part information stored in the replacement part information storage unit 800, acquires a parts list (part ID, part name, and total number) related to the work, and stores the parts list into a work-part mapping table in the integrated maintenance information (S1202). In the part information acquired here, L1 items of parts are assumed to be included. If a part name is specified in FIG. 9B, the MLI unit acquires only the part number of the part name.

Then, the maintenance location inference unit 122 analyzes a value in the action (column 917) in the maintenance work list table in the integrated maintenance information and determines whether replacement work is specified (S1203). If replacement work is specified, the MLI unit proceeds to S1204; if not so, it terminates the process.

At S1204, the maintenance location inference unit 122 searches the part shipment information storage unit 503, looks up part shipment information before the date of start of the maintenance work and with no entry of a value in the work number column, and acquires part shipment information (shipment number, part number) including any of the part numbers of the L1 items of parts acquired at S1202. That is, for particular maintenance work involving replacement of a part, the UMI unit acquires information on shipment of the part to the user and the site before the date of execution of the maintenance work. Here, part shipment information related to L2 items of parts is assumed to exist.

The maintenance location inference unit 122 proceeds to S1206, if L2 is larger than 0; if not so, it terminates the process (S1205).

At S1206, the maintenance location inference unit 122 associates the shipment number acquired at S1204 with (user ID, site ID, work number, and part number), stores these into a work-part shipment mapping table of integrated maintenance information, and terminates the process.

Although, at S1202, the MLI unit stores a work-and-part-mapping relation into the work-part mapping table using replacement part information stored in the replacement part information storage unit 800, the MLI unit may seek for a part number to be stored into the work-part mapping table, based on operation information on the machine. In the latter case, mapping relations between time-series data patterns of operation information and replacement parts are stored, and the MLI unit should search for a pattern of the mapping relations matched with a time-series data pattern of operation information before the maintenance work and acquire the part number of the replacement part number.

By the user machine inference procedure and the maintenance location inference procedure as described above, it is possible to coordinate maintenance related information managed by a provider and maintenance related information managed by a user.

The following describes an example of an embodiment in which the maintenance information coordination system 100 and the work management system 170 coordinate.

### <Maintenance Work Management Screen 1300>

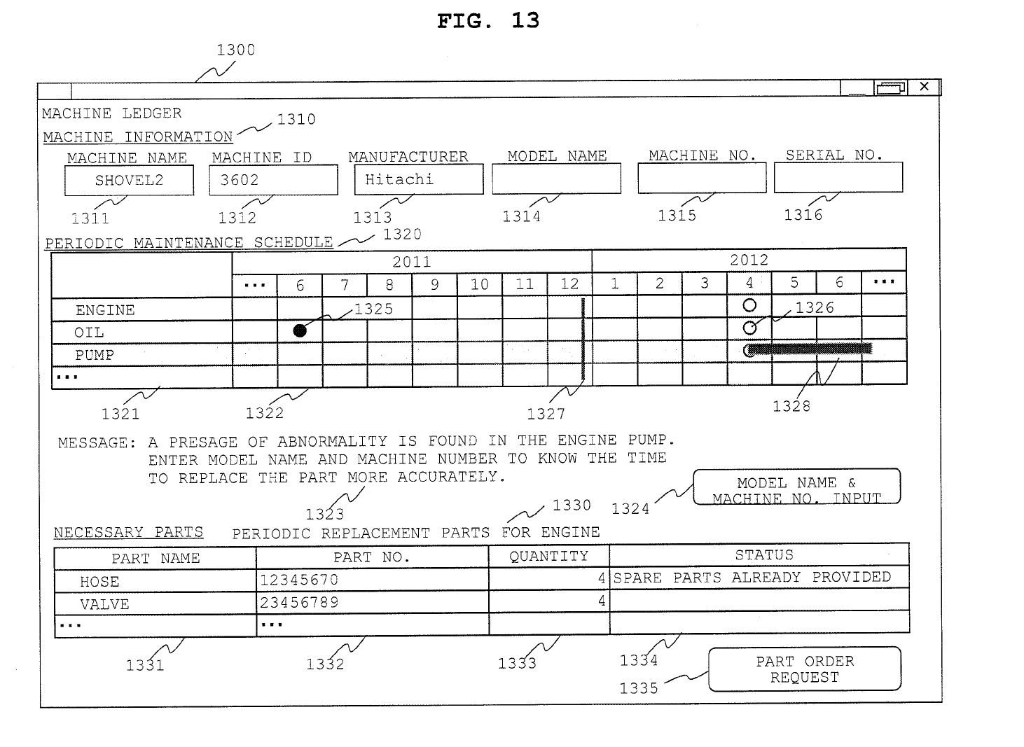

FIG. 13 is an example of a maintenance work management screen 1300 that is provided by the work management system 170 in an embodiment disclosed herein. The maintenance work management screen 1300 includes a machine information area 1310, a maintenance schedule area 1320, and part information area 1330. When making a schedule of or executing maintenance work of a machine, a user accesses the work management system 170 using the maintenance work management screen 1300. The maintenance work management screen 1300 is displayed on a terminal connected to the work management system 170 by a network via an input interface and an output interface or a communication device of the work management system 170.

The machine information area 1310 includes the following fields: machine name 1311; machine ID 1312; manufacturer name 1313; model name 1314; machine number information 1315; and serial number 1316. Here, the machine ID 1312 field allows the user to edit a machine identifier assigned by the user (user machine ID) and the serial number 1316 field allows the user to edit a machine identifier assigned by the provider (provider machine number). If information (both IDs) as above is stored as machine information in the work management system 170, the IDs are displayed in each of these fields. In the example depicted in FIG. 13, a machine name, user machine ID, and manufacturer have already been stored in the work management system 170.

The maintenance schedule area 1320 includes the following fields: maintenance location 1321; maintenance schedule 1322; message display 1323; and a model name & machine number input button 1324.

In the example depicted, the maintenance schedule area 1320 presents a maintenance work schedule table in which one row represents a location in which maintenance work is performed and one column represents a month/year when maintenance work is to be performed. Moreover, in the maintenance schedule 1322, a finished maintenance work marker 1325, a scheduled maintenance work marker 1326, a current point of time marker 1327, and a anomaly marker 1328 appear. The finished maintenance work marker 1325 or the scheduled maintenance work marker 1326 indicates that the maintenance work for a maintenance location on the row marked with the marker in the maintenance schedule is finished or scheduled. For example, in the example depicted, the following are indicated: the execution of maintenance work for engine oil has finished on June, 2011; and maintenance work for oil and a pump is scheduled to be executed on April, 2012. The current point of time marker 1327 indicates the point of time at which this screen has been displayed. In the example depicted, this screen is displayed on December, 2011. The anomaly marker 1328 indicates that a anomaly occurs with regard to a maintenance location on the row marked with the marker. A anomaly is assumed to be notified, for example, in such a way that the operation information management system 160 analyzes operation information on a machine, detects a symptom (presage) of a fault that may occur in future, and notifies it to the work management system 170 via the network. In the example depicted, it is indicated that a presage that the pump may suffer from a fault during a period from April to June, 2012 occurs.

Here, suppose that machines with user machine IDs to ‘3602’ and “3603” are operating in a “Totsuka Coal Mine” site. Also, suppose that the provider knows that the machines with machine IDs ‘36600185’ and ‘36600186’ are operating in the “Totsuka Coal Mine” site from the operation information on the machines provided by the system 100, but no mapping is made between the user machine IDs and the provider machine IDs (the machine ID of a machine with user machine ID ‘3602’ is either ‘36600185’ or ‘36600186’). In such a case, the operation information management system 100 merges anomaly information on the machines with machine IDs ‘36600185’ and ‘36600186’ and notifies the work management system 170. For example, if there are a presage that one machine may suffer from a fault on April, 2012 and a presage that the other machine may suffer from a fault on June, 2012, it is notified that there is a presage that the machines may suffer from a fault from April to June, 2012.

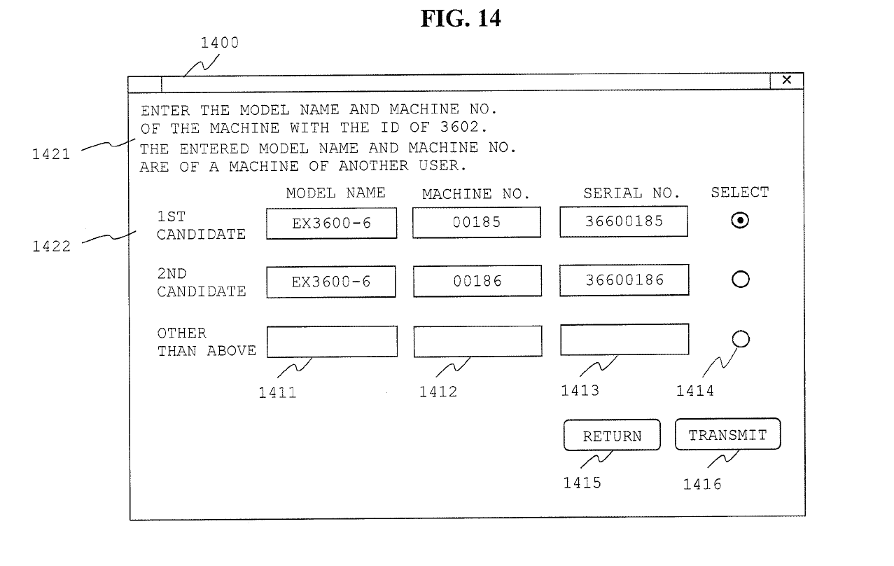

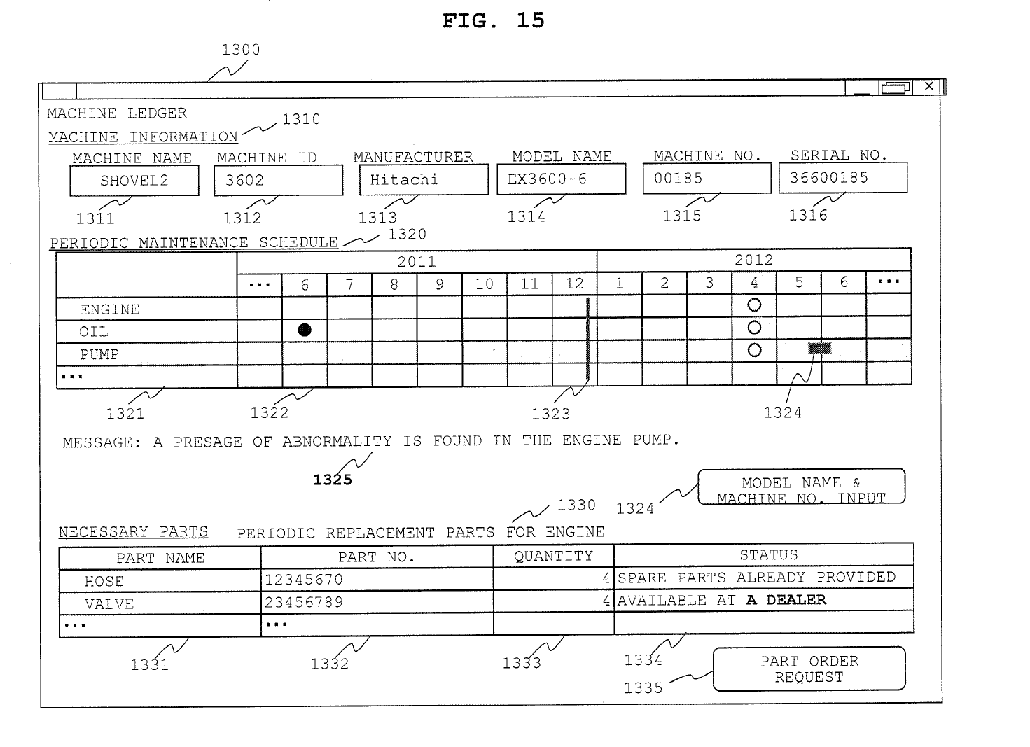

The message display field 1323 displays a message from the work management system 170 to the work management system user (usually, a person in charge of maintenance work management of machines). When the model name & machine number input button 1324 is pressed by the work management system user, a model name & machine number edit screen which is depicted in FIG. 14 is displayed.

A necessary part information area 1330 includes the following fields: part name 1331, part number 1332, quantity 1333, and status 1334, and presents information about parts necessary for a maintenance work schedule for which the work management system 170 specified locations and month/year in the maintenance schedule 1322. Among these fields, the status 1334 field displays preparation status or the like of the part. In the example depicted, it is indicated that, for maintenance work for the pump on April, 2012, four hoses with a part number ‘12345670’ and four valves with a part number ‘23456789’ are necessary and, as for the four hoses, their spare parts that the user should have already been provided.

FIG. 15 is another example of the maintenance work management screen 1300 that is provided by the work management system 170 in an embodiment disclosed herein. This is an example of the maintenance work management screen after an entry of model name and machine number as a first candidate is selected in the model name & machine number edit screen 1400 depicted in FIG. 14 and a transmit button 1416 is pressed. In the machine information area, each item of information contained in the fields of model name 1314, machine number 1315, and serial number 1316 is updated from that in the screen depicted in FIG. 13. Also in the maintenance schedule area 1320, the anomaly marker 1324 and information in the message display field 1325 depicted in FIG. 13 are updated. Here, the anomaly marker 1324 in FIG. 15 only indicates anomaly information on a machine with machine ID “36600185”, whereas, in FIG. 13, it indicates merged anomaly information on the machines with machine IDs ‘36600185’ and ‘36600186’. Also in the part information area 1330, information contained in the status 1334 field depicted in FIG. 13 is updated. In the example depicted, availability information of the part at an agency notified to the work management system 170 is displayed.

### <Model Name & Machine Number Edit Screen 1400>

FIG. 14 is an example of the model name & machine number edit screen 1400 that is provided by the work management system 170 in an embodiment disclosed herein. This screen is displayed when the model name & machine number input button 1324 in the maintenance work management screen 1300 is pressed. The model name & machine number edit screen 1400 includes the fields of model name 1411, machine number information 1412, serial number 1403, and candidate select 1414, a screen shift button 1415, a transmit button 1416, and a message display field 1421. In the model name & machine number entry screen, the model name, machine number, and serial number (machine ID assigned by the provider) of a machine inferred by the user machine inference unit 121 of the system 100 are acquired from the system 100 and displayed.

The example depicted is a case in which the system inferred that a machine with user machine ID ‘3602’ in the work management system 170 is one of the machines with machine IDs ‘36600185’ and ‘36600186’. The user of the work management system 170 would confirm the model name and machine number of the machine with user machine ID ‘3062’, turn on the candidate select 1414 of the appropriate candidate, and press the transmit button 1416. Or the user may enter a model name and machine number other than those of the machines displayed into candidate display boxes labeled “other than above”.

In the message display field 1421, a message notified from the system 100 is displayed. For example, such a message is displayed that the model name and machine number information input by the work management system 170 are incorrect.

### <User Machine Specifying Procedure>

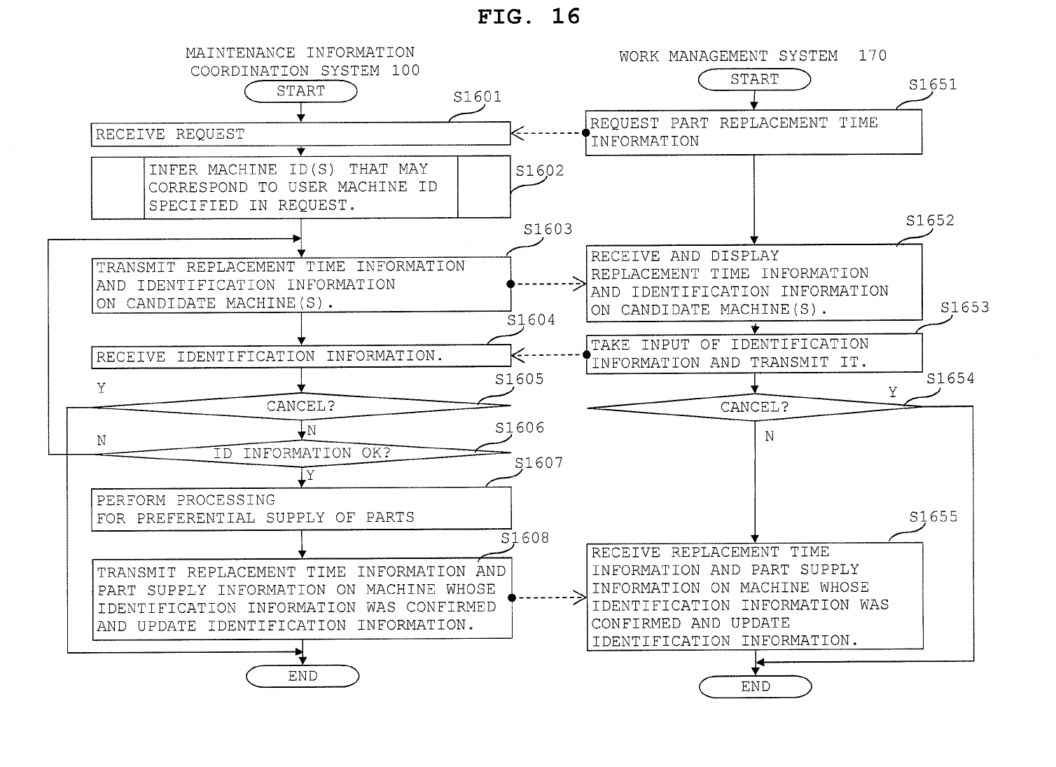

FIG. 16 presents an example of a procedure for specifying a user machine between the work management system 170 and the system 100 in an embodiment disclosed herein. This procedure prompts the user of the work management system 170 to enter machine identification information by giving an incentive such as providing information on part replacement time and part availability at an agency.

The work management system 170 sends the system 100 a notification in which it specifies a user machine ID and requests part replacement time information (anomaly information) for the part (1651).

When the system 100 receives the request (S1601), it infers a provider machine ID(s) that may correspond to the specified user machine ID (S1602). Here, the user machine mapping table presented in FIG. 9A is assumed to have been generated beforehand according to the user machine inference procedure and, at S1602, the system is assumed to search the user machine mapping table (FIG. 9A) stored in the integrated maintenance information storage unit 900. Then, for an inferred machine, the system transmits its identification information (model name and machine number or provider machine ID) and part replacement time information to the work management system 170 (S1603). If there are a plurality of provider machine IDs inferred, the system transmits, along with the above information, values of probability 1 associated with the provider machine IDs in the user machine mapping table stored in the integrated maintenance information storage unit 900. If there is no provider machine ID inferred, the system transmits a message informing so. The system may generate part replacement time information, using information on part replacement cycles which have separately been defined beforehand or the operation information management system 160 may generate this information by analyzing operation information on the machine with the provider machine ID inferred by the user machine inference unit.

The work management system 170 receives the machine's provider-side identification information (provider machine ID or model name and machine number information) and the part replacement time information, and displays them on the maintenance work management screen or the model name & machine number edit screen (S1652). Here, if having received the values of probability 1 associated with the provider machine IDs in the user machine mapping table, the work management system should display the provider-side identification to information of the machines in descending order of the values of probability 1. Then, the work management system 170 takes from the user a selection input of provider machine identification information or an input of cancel request and transmits it to the system 100 (S1653). Then, in the case of cancel request, the work management system 170 terminates the process; otherwise, it proceeds to S1655 (S1654).

The system 100 receives provider machine identification information or a cancel request (S1604). If the received message is a cancel request, the system terminates the process; if the identification information was received, the system proceeds to S1606 (S1605). At S1606, the system 100 checks the validity of the identification information (S1606). If the identification information is valid, the system proceeds to S1607; if not so, it proceeds to S1603. Here, the system judges the validity of the identification information as follows. First, the system 100 acquires machine information relevant to the provider machine ID notified to it from the machine information storage unit 200 and determines whether the machine information matches with the user ID (and the user name in user information).

Then, the system acquires user machine mapping information relevant to the provider machine ID from the user machine mapping table and makes sure that a confirmed machine ID is not specified in it. If the notified identification information is valid, the system sets 100% for probability 1 associated with the provider machine ID in the user mapping table and sets the confirmed machine ID in the confirmed machine ID column 906. Here, confirmed machine IDs are IDs assigned by the system 100 and the date of confirmation or the like associated with a confirmed machine ID is assumed to be recorded in the system 100. Moreover, the system searches for the user machine ID from the user machine mapping table and deletes user machine mapping information in which a value other than the notified provider machine ID is set. At S1607, the system performs processing for preferential supply of parts. For example, the system queries the part sales system 180 for availability information of the part in question at an agency that supplies parts to the user and acquires the result. Then, the system 100 transmits confirmed part replacement time information and part supply information to the work management system 170 and terminates the process (S1608).

The work management system 170 receives the confirmed part replacement time information and part supply information, updates user machine information, and terminates the process (S1655).

Although the system acquires availability information of the part at an agency at S1607, additionally, the system may request processing to allocate a quantity of the part available at the agency to the user and send the result as part supply information. Alternatively, the system may request the part sales system to supply the part at a discount price, if the user has ordered the part available at the agency within a certain period and send the result from the part sales system as part supply information.

By the user machine specifying procedure as described above, it is possible to coordinate maintenance related information managed by a provider and maintenance related information managed by a user.

### REFERENCE SIGNS LIST

100 . . . Maintenance information coordination system, 111 . . . Input interface, 112 . . . Output interface, 113 . . . Communication device, 114 . . . CPU, 115 . . . Memory, 116 . . . I/O unit, 117 . . . Storage device, hard disk drive, 118 . . . Program, 121 . . . User machine inference unit, 122 . . . Maintenance location inference unit, 150 . . . Network, 160 . . . Operation information management system, 170 . . . Work management system, 180 . . . Part sales system, 200 . . . Provider machine information storage unit, 300 . . . User information storage unit, 400 . . . Operation information storage unit, 500 . . . 500 . . . Part shipment information storage unit, 600 . . . Maintenance work information storage unit, 700 . . . User machine information storage unit, 800 . . . Replacement part information storage unit, 900 . . . Integrated maintenance information storage unit

1. A maintenance information coordination system that coordinates a plurality of information items about maintenance of machines, connected via a network to a work management system that manages a user's maintenance work schedules and a part sales system that supplies machine parts,
the maintenance information coordination system comprising:
a provider machine information storage unit storing information about machines including machine identifiers assigned by a provider of machines;
a user information storage unit storing information about users of the machines;
an operation information storage unit storing information about operation locations and machine operation conditions of the machines;
a maintenance work information storage unit storing information about maintenance work for the machines;
a user machine information storage unit storing information about machines including machine identifiers assigned by a user of machines;
an integrated maintenance information storage unit storing information about mapping relations between the provider machine information and the user machine information; and
a user machine inference unit that, for a machine operating in an area for which the mapping relations is going to be inferred, infers an identifier assigned to the machine by the machine provider from the provider machine information, the user information, and the operation information, further infers a machine identifier assigned by the user to the machine with the identifier from the operation information, the user machine information, and the maintenance work information, and stores a mapping relation between the machine identifier assigned by the provider and the machine identifier assigned by the user into the integrated maintenance information storage unit.

2. The maintenance information coordination system according to claim 1, further comprising:
a part shipment information storage unit storing information about shipment of maintenance parts for machines;
a replacement part information storage unit storing information about replacement parts for machines; and
a maintenance location inference unit that infers from the maintenance work information a location for which maintenance work was executed and work action for respective maintenance work included in the maintenance work information, infers a replacement part for use in the location from a result of the above inference and the replacement part information, and, if the work action is part replacement, infers a transaction identifier relevant to the replacement part from the part shipment information, and stores the transaction identifier into the integrated maintenance information storage unit.

3. The maintenance information coordination system according to claim 2,
wherein the user machine inference unit receives a machine identifier assigned by the user from the work management system, acquires candidate machine identifiers assigned by the provider which may correspond to the machine identifier assigned by the user from the integrated maintenance information storage unit and transmits these candidate machine identifiers to the work management system, receives information specifying a machine identifier assigned by the provider corresponding to the machine identifier assigned by the user from the work management system, and, after deciding that the received information represents a mapping relation that is uniquely determined from the provider machine information or other mapping relations stored in the integrated maintenance information storage unit, stores the mapping relation into the integrated maintenance information storage unit.

4. The maintenance information coordination system according to claim 3,
wherein if the machine identifier assigned by the provider corresponding to the machine identifier assigned by the user, received from the work management system, is uniquely determined, the user machine inference unit transmits part replacement time information inferred based on the operation condition of the machine with the machine identifier, along with the identifier, to the work management system.

5. The maintenance information coordination system according to claim 4,
wherein with regard to a part whose replacement time information is transmitted to the work management system, the user machine inference unit transmits a request for preferential supply such as preferential allocation of a quantity of the part available to the user or selling at a discount price to the part sales system and transmits a result of the request as part supply information to the work management system.

6. A method for maintenance information coordination to coordinate a plurality of information items about maintenance of machines by using a computer, the method comprising:
holding provider machine information about machines including machine identifiers assigned by a provider of machines, user information about users of the machines, operation information about operation locations and machine operation conditions of the machines, maintenance work information about maintenance work for the machines, user machine information about machines including machine identifiers assigned by a user of machines, and integrated maintenance information about mapping relations between the provider machine information and the user machine information;
for a machine operating in an area for which the mapping relations is going to be inferred, inferring an identifier assigned to the machine by the machine provider from the provider machine information, the user information, and the operation information;
inferring a machine identifier assigned by the user to the machine with the identifier from the operation information, the user machine information, and the maintenance work information, and;
storing a mapping relation between the machine identifier assigned by the provider and the machine identifier assigned by the user into the integrated maintenance information.

7. The method for maintenance information coordination according to claim 6, the method further comprising:
holding part shipment information about shipment of maintenance parts for machines and replacement part information about replacement parts for machines;
inferring from the maintenance work information a location for which maintenance work was executed and work action for respective maintenance work included in the maintenance work information;
inferring a replacement part for use in the location from a result of the above inference and the replacement part information; and
if the work action is part replacement, inferring a transaction identifier relevant to the replacement part from the part shipment information, and storing the transaction identifier into the integrated maintenance information.

8. The method for maintenance information coordination according to claim 7, the method further comprising:
receiving a machine identifier assigned by the user from a work management system that manages a user's maintenance work schedules, connected to the computer via a network;
acquiring candidate machine identifiers assigned by the provider which may correspond to the machine identifier assigned by the user from the integrated maintenance information and transmitting these candidate machine identifiers to the work management system;
receiving information specifying a machine identifier assigned by the provider corresponding to the machine identifier assigned by the user from the work management system; and
after deciding that the received information represents a mapping relation that is uniquely determined from the provider machine information or other mapping relations stored in the integrated maintenance information, storing the mapping relation into the integrated maintenance information.

9. The method for maintenance information coordination according to claim 8, the method further comprising:
if the machine identifier assigned by the provider corresponding to the machine identifier assigned by the user, received from the work management system, is uniquely determined, transmitting part replacement time information inferred based on the operation condition of the machine with the machine identifier, along with the identifier, to the work management system.

10. The method for maintenance information coordination according to claim 9, the method further comprising:
with regard to a part whose replacement time information is transmitted to the work management system, transmitting a request for preferential supply such as preferential allocation of a quantity of the part available to the user or selling at a discount price to a part sales system that supplies machine parts, connected to the computer via the network, and transmitting a result of the request as part supply information to the work management system.
